(19) United States
(12) Patent Application Publication
(10) Pub. No.: US 2021/0138599 A1
(43) Pub. Date: May 13, 2021

(54) MACHINE TOOL

(71) Applicant: IVOCLAR VIVADENT AG, Schaan (LI)

(72) Inventor: Andreas Habit, Tschagguns (AT)

(21) Appl. No.: 17/094,369

(22) Filed: Nov. 10, 2020

(30) Foreign Application Priority Data
Nov. 11, 2019 (EP) 19208410.1

(51) Int. Cl. B23Q 11/08; B23B 31/26; B23Q 1/70

(52) U.S. Cl. CPC B23Q 11/0883; B23Q 11/1023; B23Q 1/70; B23B 31/261

(57) ABSTRACT

A machine tool comprising tool spindle (12) having a chuck (26) and a spindle motor, in which the chuck (26) can be actuated for the purpose of receiving and releasing a tool, a sealing air channel (40) is provided which extends at least partially radially outside the chuck (26). The sealing air channel (40) terminates in or at a protective cap (34).

### CROSS-REFERENCE TO RELATED APPLICATIONS

This application claims priority to European patent application No. 19208410.1 filed on Nov. 11, 2019, the disclosure of which is incorporated herein by reference in its entirety.

### TECHNICAL FIELD

The invention relates to a machine tool, in particular, a machine tool comprising a spindle motor and a tool spindle which extends upwards therefrom or towards the side.

### BACKGROUND

Numerous designs of machine tools have become known. For specific applications, machines of the type 5/0 are particularly suitable, i.e., those in which 0 movement axes of the tool are combined with 5 movement axes of the workpiece.

The movement axes of the workpiece are provided typically via a robot arm and are presented as 3 translational and 2 rotational movement axes. In contrast thereto, the rotating tool remains stationary on a tool spindle which is driven by a spindle motor and is positionally fixed.

When the workpiece is being machined by the tool, chips are produced which turn out to be different depending upon the material combination of workpiece and tool used.

If e.g., ceramic dental restorations are milled, this produces not only granular but also almost dust-like accumulations.

While the granular accumulations sink to the bottom on account of their own weight, the dust-like accumulations are initially present in the form of a type of mist which falls only slowly but which, when the spindle motor is at a standstill after completion of the machining procedure, forms a dust layer at the bottom of the milling machine or e.g., a rotary or lathe grinding machine.

If the machine tool has a spindle which extends upwards from the spindle motor and the spindle motor is thus arranged upright, the accumulations also accumulate at that location, i.e., also at the transition between the spindle and the spindle housing.

However, even in the case of a horizontally extending spindle, accumulations pass into the transition region between the spindle and the spindle housing by reason of the turbulence generated during operation.

In order to reduce contamination of the milling space, it has become known to clean the milling space via air nozzles which are attached in a particularly preferred manner to the upper edge of the workspace.

A suction opening which is to ensure removal of the accumulations is then typically located diametrically opposite said air nozzles.

Such a solution is known e.g. from EP 3 012 065 A1 and corresponding U.S. Ser. No. 10/562,144, which is hereby incorporated by reference in its entirety. U.S. Pat. Nos. 3,542,372, 10,813,255, 10,201,882, 10,275,722, 9,744,596, 9,561,570 and 9,999,954 are directed to machine tools and are hereby incorporated by reference.

It has also become known to clean, in particular, the machining region, i.e., the region where the tool lies against the workpiece. For this purpose, according to EP 3 338 945 A1, it has become known to arrange nozzles on the tool spindle, by means of which water and also compressed air can be selectively supplied to the machining region in order to keep this important region free of accumulations as far as possible.

Rotary or lathe grinding machines which have been mentioned here by way of example typically have a comparatively low required torque, but have a high rotational speed of the spindle motor for the corresponding desired machining progress. This is typically 40,000 revolutions per minute (rpm) but can also be up to 80,000 rpm.

At such a high speed, it is absolutely essential to have a high-precision bearing arrangement. Ball bearings, which have a bearing clearance of about 500 nm and can absorb the required supporting forces even at such high speeds, are used.

In order to support the spindle, 2 to 4 ball bearings are then typically provided one on top of the other.

However, at this high speed even one grain of dust would have a wearing effect if it passes into the ball bearings track.

Therefore, the region of the bearings has bearings air flowing therethrough in a bearings air channel. The bearings air is cleaned by filters which are connected in series, i.e., initially a coarse filter then a fine filter, and forms essentially a cylindrical gap around the tool spindle.

This gap terminates slightly above the uppermost ball bearing. When the rotary or lathe grinding machine is switched off, and even during operation as a result of turbulence, dust-like accumulations will possibly settle therein.

However, before the spindle motor is switched on, the bearing air is switched on to ensure that the accumulations at that location should be discharged. However, the accumulations are sometimes sticky and so the discharge procedure is not always successful.

Furthermore, at such high rotational speeds it is important that the tool is held concentrically, i.e., free of any deviations, in the chuck typically used. For this purpose, self-centering clamping jaws are preferred which slide on oblique surfaces and clamp the tool by means of an axial spring pressure. When changing the tool, a rearward pressure plate ensures that the clamping jaws are moved forwards such that they are guided radially outwards on the oblique surfaces and release the tool.

The compressed air for releasing the clamping jaws such that the tool can be taken off from the chuck is provided at a pressure between 6 and 8 bar, i.e., substantially more than the bearing air which requires e.g., a pressure of 2 bar.

In order to also keep the region of the clamping jaws and thus of the chuck free of accumulations, it has been proposed to direct a short pulse of air through the chuck, said pulse of air then being provided to ensure cleaning of the accumulations at that location if the tool is being changed so that, in turn, the next tool can be automatically centered.

However, specifically in the case of machine tools which have been standing for longer periods the accumulations can become baked on and as such cannot be removed or cannot be completely removed by the pulse of compressed air.

This results in slight eccentricity or off-balance and thus increased tool wear or less precise production of the workpiece.

A corresponding workpiece can be e.g., a ceramic dental restoration part, for which a particularly high level of precision is known to be important.

### SUMMARY

In contrast thereto, the object of the invention is to provide a machine tool, which is suitable in particular for producing dental restoration parts and which also achieves good precision results over the long-term.

In accordance with the invention, this object is achieved by the claims. Advantageous developments are apparent from the dependent claims.

In accordance with the invention, provision is made to set the sealing air such that it also blocks the ingress of accumulations to the chuck.

For this purpose, in accordance with the invention, a protective cap is provided which covers and shields the region between the tool and the spindle housing. The protective cap also renders it possible for the sealing air channel to be extended and subsequently to terminate at the cap.

As a result, the end of the sealing air channel is displaced in the direction of the tool.

By means of a preferably provided annular gap on the protective cap, at which the sealing air channel terminates, the flow resistance in the air channel is slightly increased, and accordingly at the same pumping power and the same excess pressure the flow speed in the air channel is slightly reduced. The annular gap extends preferably between the tool and the chuck on the one hand and the protective cap on the other hand. Annular gap in this case is to be understood to mean any at least partial ring-shaped configuration of a gap.

Surprisingly, however, this does not result in an impaired cleaning effect and greater susceptibility to failure in any way whatsoever but quite conversely results in improved operating reliability.

The protective cap in accordance with the invention ensures that the clamping jaws of the spindle remain free of accumulations. No imbalance is caused at this location, which is important with regard to the high motor rotational speeds of e.g., 60,000 rpm.

Such high-speed machine tools frequently have a so-called centrifugal disk in order to compensate for any out-of-roundness. The centrifugal disk has so-called balancing bores on its outer periphery. These balancing bores reduce, or even completely compensate for, the imbalance by removing material at the corresponding angular position.

The centrifugal disk is fixedly mounted on the spindle adjacent the spindle housing. Therefore, it likewise rotates at a high rotational speed, with corresponding centrifugal force on its outer periphery. However, the balancing bores become easily clogged with the resulting, fine dust-like abrasion product.

In accordance with the invention, the sealing air channel on the spindle is covered by the protective cap. It preferably covers the clamping jaws of the chuck. If a centrifugal disk is provided, it is likewise covered.

In accordance with the invention, the sealing air channel also extends through the protective cap. The sealing air channel terminates at the end of the protective cap close to the tool, preferably at an annular gap which extends between the protective cap and a rotating part of the machine tool.

Therefore, the entire front region of the spindle, including the tool holder and the shaft of the tool, is covered and protected against contamination. In one advantageous embodiment of the invention, an excess pressure space is created by the protective cap above the chuck, i.e., between the spindle and the tool.

This excess pressure space is supplied with sealing air and terminates in an annular gap located above, where the sealing air blows out and thus prevents accumulations from being able to enter the chuck and other regions of the machine tool.

It is particularly favourable that the sealing air for the chuck can be combined with the sealing air for the rolling bearings. For this purpose, the sealing air passes preferably initially through the bearings air channel of the rolling bearings and subsequently it is guided there further upwards and so the sealing air channel extends as far as above the upper end of the chuck or optionally as far as below at the same amount.

In one advantageous embodiment, provision is made that the protective cap consists of a material which is softer and more elastic than metal, in particular synthetic or composite material, such as, but not limited to polypropylene, polyethylene, polyamide, acrylonitrile butadiene styrene, and/or fibre-reinforced composite material. The protective cap can be produced inexpensively as an injection-molded part.

In one advantageous embodiment, provision is made that the protective cap is fixedly mounted on the spindle housing. Said protective cap can be mounted in any suitable manner.

In one advantageous embodiment, provision is made that the protective cap is fabricated of a sturdy material like hard plastic or metal. This allows the gap dimension of the annular gap between the protective cap and the spindle to have a constant width, especially a constant width between 0.05 mm and 1.5 mm and preferably between 0.15 and 0.8 mm, and particularly preferably between 0.3 and 0.5 mm, even under high rotational speeds like rotational speeds of more than 30,000 rpm such as 60,000 rpm. This can be achieved by both the spindle and the protective cap being made from metal. In another embodiment the spindle is made from metal and the protective cap from a plastic material, especially from a hard plastic.

Some examples of hard plastic include, but are not limited to, acrylic, polymethyl methacrylate (pmma), polycarbonate (pc), high density polyethylene (pe), polypropylene (pp), polyethylene terephthalate (pete or pet), polyvinyl chloride (pvc), and acrylonitrile-butadiene-styrene (abs).

The gap width preferably stays constant with a tolerance between 1 percent and 8 percent of the gap width, irrespective of the operating temperature of the inventive machine tool, By this, the gap acts as a reliable “nozzle” to blow away any chips and any contamination of the working area, and, as there is no contact between said protective cap and said spindle, there is no wearing.

The narrow part at the front end of the protective cap, i.e. the gap, extends over at least 20 percent, preferably over at least 30 percent of the axial total length of the protective cap. This allows to keep the inner of the spindle, especially the lower sealing air channel and in particular the bearing air channel, free from dust-like accumulations that could settle therein, even after switching off the machine tool, e.g. a grinding machine.

The protective cap is preferably detachable. It can be fitted, e.g., in that a defined position is specified by placement on the spindle housing. It is also possible that the protective cap or other fixed part is provided with a latching device which centers the protective cap, having a web or tongue which protrudes radially inwards and is formed on the protective cap, and a matching groove on the housing or the other fixed part.

In contrast, in a modified embodiment the protective cap is not detachable but instead is fixedly connected or even integral with the machine tool overall.

In the case of this embodiment, the spindle which is intended to clamp the tool protrudes from the spindle housing and the spindle housing forms, at its front end, a protective cap towards the spindle. The protective cap has, at its front end, a diameter which is smaller than its other, rearward end and forms, at the front end, an annular gap opposite a rotating part of the machine tool or the tool. The excess pressure space which is supplied with air terminates at the annular gap. It extends at the end of a sealing air channel.

Preferably, the annular gap and the protective cap are provided at a point where clamping and removal of the tool are not hindered.

The spindle preferably has a chuck which can be actuated automatically and is supplied with compressed air.

In one advantageous embodiment, provision is made that the protective cap covers a centrifugal disk with balancing bores, or covers at least as many of the rotating parts of the spindle as possible.

In one advantageous embodiment, provision is made that the sealing air channel is formed upstream of the protective cap as a bearing air channel.

In one advantageous embodiment, provision is made that the chuck has a compressed air drive which, in order to open the clamping jaws, acts upon said jaws from the rear via a pressure plate, and in particular that the compressed air drive supplies the sealing air channel via a pressure reducing valve, or that two independent compressed air connections are provided, or that the chuck has an electric drive.

In a further advantageous embodiment, provision is made that, when the chuck is open, a pulse of air of in particular more than 6 bar can be output along the chuck and the tool, with chips being cleaned from the chuck.

In one advantageous embodiment, provision is made that the annular gap and the protective cap have an orientation which is coaxial to the tool axis or have an orientation which deviates at most by +/−10° from the axis of the tool spindle.

In one advantageous embodiment, provision is made that a plurality of nozzles are attached distributed around the tool on the tool spindle or the machine tool, said nozzles being directed at least partially onto a machining region between the tool and the workpiece and being provided in particular in a nozzle plate which extends in the manner of a circular ring.

Preferably, the design is selected such that the annular gap, as viewed in the axial direction, is formed between the tool spindle overall and the tool on the protective cap radially on the inside on said cap and has a comparatively high flow resistance and accordingly creates the excess pressure space.

This annular gap can be produced having an axially directed exit surface of the annular gap, having an exit surface which is directed obliquely with respect to the tool axis or having an exit surface which is radial or is turned slightly obliquely forwards.

It is easily possible to produce a radial exit surface particularly when the tool is provided with a tool ring. Typically, such a tool ring is already provided in modern tools for machine tools and is used in order to be able to handle the tool easily on a gripping fork when replacing the tool. Alternatively, provision is made to place or receive the tool in a holder which matches the ring.

It is understood that the effects in accordance with the invention are especially clear in a particularly favourable manner in the case of a machine tool having a vertical tool spindle. Fundamentally, it is favorable to provide the additional sealing air for the tool spindle even when a horizontal tool spindle is used because, by reason of the turbulence caused by the movement and the air flows in the milling space, there is then also the risk that the chuck will become contaminated with accumulations.

The invention will now be described with reference to a machine tool having an upwardly facing spindle. In the case of such a machine tool, the spindle housing is typically arranged in a positionally fixed manner, in particular at the bottom of the milling space, and a robot arm is provided which carries and guides the workpiece, preferably in 4 or 5 spatial axes.

In this case, a vertical tool spindle is to be understood to be one, in which the tool is located at the top and is introduced into the chuck from the top downwards in order to be clamped at that location.

It is understood that, instead of this, it is also possible in accordance with the invention to provide a machine tool, in which another arrangement of the tool spindle is provided, e.g., horizontal or movable in space.

In accordance with the invention, the housing of the tool spindle having the protective cap and in particular with the creation of the excess pressure space is extended further upwards in comparison with the prior art. Thus, the sealing air gap does not terminate at or just above the end of the housing of the machine tool, but instead a few cm or about 2 cm above this end, thus forming the annular gap.

The excess pressure space extends preferably between the sealing air channel and the annular gap, which is arranged in accordance with the invention, on the protective gap.

The housing of the tool spindle is typically conically tapered towards the top. It is adjoined harmoniously by the protective cap which can have a slender profile with an S-shaped contour.

Nevertheless, sufficient space remains to provide a nozzle plate for air nozzles which extend radially outside the protective cap on a surface, of which the normal is axially parallel. The air nozzles which are known per se then terminate further above.

This has the additional advantage that the exit of the flow medium, i.e., air or water, through these cleaning nozzles has moved closer to the machining region and so better and more targeted cleaning is possible at this location.

It is preferable that the sealing air channel extends at least partially radially outside the chuck, that the chuck can be actuated for receiving and releasing a tool, and that the sealing air channel terminates in or at the protective cap.

It is preferable that the annular gap is provided between the protective cap and the tool or the chuck or a rotating part of a machine tool, of which one gap side is formed by the tool or the chuck or another rotating part of the machine tool and the other gap side is formed by the protective cap, and that the other gap side is formed by the protective cap at a nozzle flank.

It is preferable that the protective cap is bell-shaped or trapezoidal or has an S-shape or trapezoidal contour when viewed in cross-sectional view.

It is preferable that the protective cap terminates at the annular gap and is fitted, screwed or otherwise fastened onto a housing of the spindle or the machine tool or another fixed part.

It is preferable that a rear end of the protective cap is fixedly connected to a part of the machine tool by forming a press fit, form-fit, friction fit or rotation and is circumferentially sealing and/or is detachable.

It is preferable that the protective cap has a radial extension or diameter in a front region adjacent to the annular gap and extending over at least 20% of an axial total length, with respect to the rotating parts of the machine tool, the radial extension can exceed that of the rotating parts by less than 30%.

It is preferable that a positive pressure space is formed in the protective cap and the flow resistance of the air through the positive pressure space and the protective cap at this point is less than in the region of the annular gap which closes off the positive pressure space.

It is preferable that the tool has at least one tool ring which protrudes radially outwards, and wherein the sealing air channel terminates on the tool ring or terminates at maximum of 1 cm below the tool ring.

It is preferable that a bearings air channel is formed on bearings of the spindle and is supplied with positive pressure between 0.5 bar and 6 bar and has a flow volume between 5 l/min and 80 l/min.

It is preferable that a bearings air channel is formed on bearings of the spindle and supplies the sealing air channel between the spindle and spindle housing.

It is preferable that the annular gap on the protective cap has a gap dimension between 0.05 mm and 1.5 mm.

It is preferable that the machine tool includes a spindle which is intended for clamping a tool and a spindle housing, on which the spindle is mounted, which spindle protrudes from the spindle housing at a front end of the spindle housing, wherein the spindle housing forms, at its front end, a protective cap towards the spindle, which protective cap has, at the protective cap's front end, a diameter, which is smaller than a diameter at the protective cap's other, rearward end, and forms, at the front end, an annular gap with a rotating part of the machine tool or the tool, at which annular gap, a positive pressure space supplied with air, terminates.

It is preferable that the a protective cap is provided for mounting or fastening on a fixed part of a machine tool and has at a front end, a diameter smaller than a diameter at the other, rearward end and has, at the front end, a slender shape in comparison to the other rearward end, the slender shape approximating the end-side inner diameter at the front end.

It is preferable that the protective cap is fitted onto the spindle housing when in the state of being fitted onto the spindle housing, has an annular nozzle flank which, together with a rotating part of the machine tool, as a second annular nozzle flank, forms a nozzle in the form of an annular gap.

It is preferable that the protective cap covers a sealing air channel and displaces the end of the sealing air channel towards the tool or another rotating part.

It is preferable that the seat of the protective cap is formed as a threaded fit, a plug fit and/or as a press fit, by which the protective cap can be mounted on a fixed part of the machine tool by press fit and in a centered manner and/or wherein the protective cap is formed on a seat in such a manner that it functions as a replacement part or as an accessory part for existing machine tools and fits onto fixed parts thereof.

It is preferable that the protective cap has a radial extension in a front region adjacent to the annular gap and extending over at least 30% of an axial total length, with respect to the rotating parts of the machine tool, a radial extension which exceeds that of the rotating parts by less than 15%.

It is preferable that a bearings air channel is formed on bearings of the spindle and is supplied with positive pressure between 1 and 3 bar, and has a flow volume between 20 to 50 l/min.

It is preferable that an annular gap on the protective cap has a gap dimension in one of the following ranges: between 0.05 and 1.0 mm or between 0.15 and 0.8 mm or between 0.3 and 0.5 mm.

It is preferable that the bearings air passes through the bearings of the spindle and is fed with filtered air or an ultra high purity, to ensure the absence of particles in the bearings of the spindle.

It is preferable that at least one filter is provided upstream of the bearing air channel, preferably first at least one coarse filter upstream of at least one fine filter, to ensure the purity of the bearing air.

It is preferable that the gap of the annular gap on the protective cap is not deformable, especially while rotating.

It is preferable that the gap width is constant, within a tolerance of 5 percent of the gap width, in all operating modes and operation states of said machine tool.

It is preferable that the protective cap and the spindle are made from a solid and undeformable material.

### BRIEF DESCRIPTION OF THE DRAWINGS

Further advantages, details and features will be apparent from the following description of two exemplified embodiments of the invention with reference to the drawings in which

FIG. 1 shows a part of a machine tool in accordance with the invention, illustrating a part of the tool spindle and the tool;

FIG. 2 shows a sectional view through a part of a machine tool in accordance with the invention, illustrating the tool spindle in its upper part, including the tool, in a view enlarged compared to FIG. 1;

FIG. 3 shows a modified embodiment of a protective cap in accordance with the invention;

FIG. 4 shows an enlarged view of a portion of FIG. 2; and

FIG. 5 shows a marked flow path of the air channel.

### DETAILED DESCRIPTION

FIG. 1 illustrates a part of a machine tool 10 in accordance with the invention. The machine tool 10 has a tool spindle 12 which carries a tool 14 and holds it in a clamped manner.

The tool spindle 12 has a spindle housing 16. In the machining region 22, the tool 14 has contact with a workpiece, not illustrated, and so chips are produced at this location.

The tool 14 has a shaft 24 which is held in a clamped manner in a chuck 26 illustrated in FIG. 2.

In the illustrated exemplified embodiment, the tool 14 has a tool ring 28 with three annular protrusions or flanges or webs, not illustrated, between which annular grooves extend. The annular grooves serve to hold the tool 14 in a gripping fork of a robot arm, not illustrated, and are thus used for tool replacement purposes.

The tool 14 has the annular tool ring 28 which delimits or borders the shaft 24 at the top. The tool ring 28 serves at the same time as a stop for introducing the tool 14 into the chuck 26.

Whereas here with reference to the drawing the reference sign 12 designates the spindle, it is understood that this can also be understood to be a rotating part of the spindle or the rotor. The chuck 26 is not illustrated in its actual form but instead is indicated only schematically.

During operation of the machine tool 10, accumulations are caused to swirl up by air nozzles which are additionally provided on the housing side. The accumulations are removed at least partially by means of bottom-side suction.

However, if the machine tool 10 is switched off, the supply to the air nozzles is also switched off and therefore the resulting milling dust and the associated chips can accumulate.

The accumulations occur inter aria also on the tool spindle 12 and up to now accumulations could also pass into the interior of the tool spindle 12.

Since the machine tool 10 operates at more than 30,000 rpm, it is not possible to provide a sealing ring because such a sealing ring would immediately wear out at rotational speeds above 5000 rpm.

The machine tool 10 has a centrifugal disk 30, as can be seen in FIG. 2. It is fixedly attached to the spindle 12.

On its outer periphery, the centrifugal disk 30 is the part of the spindle 12 with the largest radius. Furthermore, it has imbalance bores in its outer regions. They are provided in order to compensate for any imbalance of the spindle 12.

The centrifugal disk 30 covers a sealing air channel 40 which extends between the spindle housing 16 and the spindle 12.

The sealing air channel 40 forms the end of a bearings air channel 42, in which rolling bearings 36 and 38 are arranged which have bearing air flowing therethrough.

Since the sealing air channel 40 is substantially narrower than the bearing air channel 42, the flow rate at this location is higher. Nevertheless, accumulations could previously pass therein and possibly impair the bearings 36 and 38.

Furthermore, accumulations could previously reach the region of the centrifugal disk 30 and clog the imbalance bores. This impaired balancing of the spindle 12 could lead to bearing damage.

In accordance with the invention, a protective cap 34 is provided which is placed over the upper end of the spindle housing 16.

The protective cap 34 covers the upper end of the spindle housing 16 and thus in particular also the region of the centrifugal disk 30. The protective cap 34 extends along the front region of the spindle 12 and at that location hugs the outer contour thereof.

The protective cap 34 is mounted on the spindle housing 16 and does not rotate with respect thereto. Since the protective cap 34 covers the centrifugal disk 30, it is supplied and filled by the air from the sealing air channel 40. An excess or positive pressure space 44 is produced within the protective cap 34.

This excess or positive pressure space extends as far as an annular gap 46, at which the protective cap 34 terminates radially just outside the spindle 12. The annular gap 46 has a width of 0.4 mm, wherein the gap dimension can be adapted to requirements within wide ranges and e.g., can be between 0.05 mm and 1.5 mm.

The bearings air channel 42 has an excess or positive pressure between 2 and 3 bar, wherein the over or excess or positive pressure can also be in the range of 0.5 and 6 bar.

The air flowing through can amount to about 15 l/min, wherein the flow volume can also be in the range of 5 and 50 l/min.

The excess pressure space 44 has a slightly lower excess or positive pressure of e.g., 0.5 bar.

The annular gap 46 is formed on one gap side by the chuck 26 of the spindle 12 and is formed on its other gap side by the protective cap 34.

The protective cap 34 has a substantially S-shaped contour when viewed in cross-sectional view and at one side of the radius. It is fitted onto the spindle housing 16 by means of a press fit. Other shapes include trapezoidal and bell-shaped; bell-shaped defined as a ‘bell curve’ which is defined as a mathematical function having a characteristic “bell”-shaped curve. These functions are typically continuous or smooth, asymptotically approach zero for large negative/positive x, and have a single, unimodal maximum at small x. Hence, the integral of a bell-shaped function is typically a sigmoid function. Bell shaped functions are also commonly symmetric.

The spindle housing 16 has at that location a circumferential annular groove 48, into which a radially inwardly protruding web or flange or protrusion 56 of the protective cap 34 enters. As a result, the protective cap 34 is securely centered.

In a manner particularly preferred in accordance with the invention, the air supply in the bearings air channel 42 can be operated intermittently. A pulse of air can substantially improve the cleaning of the chuck 26.

A modified embodiment of the protective cap 34 can be seen in FIG. 3. Instead of the web 56 shown in FIG. 2, a support surface 52 is provided therein which is supported on the radially outer region of the spindle housing 16 and is likewise used for centring purposes.

It can be seen that the protective cap 34 can hug the outer contour of the spindle housing 16 and also of the tool spindle 12, which is assisted by the S-shape, as mentioned above.

The protective cap 34 is intended for a machine tool comprising a spindle, a spindle housing and a tool. At its rearward end 54, the protective cap has a shape which makes it suitable for mounting on a fixed part of the machine tool, such as the spindle housing 16. At its front end 58, i.e., close to the tool, it has a diameter smaller than the diameter at its other, rearward end, and has a slender shape approximating the end-side inner diameter 60.

The protective cap 34, when in the state of being fitted onto the spindle housing 16, has an annular nozzle flank 62 which, together with a rotating part of the machine tool, in particular the tool 14 or the spindle 12, as a second annular nozzle flank, forms a nozzle in the shape of the annular gap 46.

The protective cap 34, when in the state mounted on the machine tool 10, covers the sealing air channel 40 of the machine tool 10, in particular towards the tool 14, and in this respect displaces the end of the sealing air channel 40 forwards, i.e. towards the tool 14.

The seat of the protective cap 34 is formed as a press fit, by means of which the protective cap 34 can be mounted on a fixed part of the machine tool 10 by interference fit and in a centered manner. At this location, the protective cap 34 is formed on its seat in such a manner that it functions as a replacement part or as an accessory part for existing machine tools 10 and fits onto fixed parts thereof.

FIG. 4 shows an enlarged view of a portion of FIG. 2, showing the sealing air channel (40). FIG. 5 shows a marked flow path 65 of sealing air channel 40 a part of which is formed by the bearings air channel 42 and thus runs through the rolling bearings 36 and 38. Exemplarily, this flow path is only shown on one side of the spindle but it is to be understood that a corresponding flow path is on the other side as well.

Upstream of the rolling bearings 36 and 38, preferably at the inlet of the bearing air channel 42, at least one filter, preferably first at least one coarse filter upstream of at least one fine filter, is connected to ensure the purity of the bearing air. If more filters are used they are connected in series, while the air is filtered by ever finer filters to maximize air purity. This is essential because even slight impurities in the bearing air, like fine dust grains, could lead to a substantial damage in the bearings or even destruction of the bearings at high rotational speeds like the ones used in the invention, especially at rotational speeds of more than 30,000 rpm, and even up to 60,000 rpm.

1. A machine tool comprising
a tool spindle (12) having a chuck (26) and a spindle motor,
a sealing air channel (40) which extends at least partially radially outside the chuck (26),
wherein the chuck (26) can be actuated for receiving and releasing a tool, and
wherein the sealing air channel (40) terminates in or at a protective cap (34).

2. The machine tool as claimed in claim 1,
wherein an annular gap (46) is provided between the protective cap (34) and the tool (14) or the chuck (26) or a rotating part of a machine tool (10), of which one gap side is formed by the tool (14) or the chuck (26) or another rotating part of the machine tool (10) and the other gap side is formed by the protective cap (34).

3. The machine tool as claimed in claim 1,
wherein the protective cap (34) is bell-shaped or trapezoidal or has an S-shape or trapezoidal contour when viewed in cross-sectional view.

4. The machine tool as claimed in claim 2,
wherein the protective cap (34) terminates at the annular gap (46) and is fitted, screwed or otherwise fastened onto a housing (16) of the spindle (12) or the machine tool (10) or another fixed part.

5. The machine tool as claimed in claim 1,
wherein a rear end (58) of the protective cap (34) is fixedly connected to a part of the machine tool (10) by forming a press fit, form-fit, friction fit or rotation and is circumferentially sealing and/or is detachable.

6. The machine tool as claimed in claim 1,
wherein the protective cap (34) comprises a radial extension or diameter in a front region adjacent to the annular gap (46) and extending over at least 20% of an axial total length, with respect to the rotating parts of the machine tool (10), the radial extension (64) which exceeds that of the rotating parts by less than 30%.

7. The machine tool as claimed in claim 1,
wherein a positive pressure space (44) is formed in the protective cap (34) and the flow resistance of the air through the positive pressure space (44) and the protective cap (34) at this point is less than in the region of the annular gap (46) which closes off the positive pressure space (44).

8. The machine tool as claimed in claim 1,
wherein the tool (14) has at least one tool ring (28) which protrudes radially outwards, and
wherein the sealing air channel (40) terminates on the tool ring (28) or terminates at maximum of 1 cm below the tool ring (30).

9. The machine tool as claimed in claim 1,
wherein a bearings air channel (42) is formed on bearings (36, 38) of the spindle (12) and is supplied with positive pressure between 0.5 bar and 6 bar and has a flow volume between 5 l/min and 80 l/min.

10. The machine tool as claimed in claim 1,
wherein a bearing air channel (42) is formed on bearings (36, 38) of the spindle (12) and supplies the sealing air channel (40) between the spindle (12) and spindle housing (16).

11. The machine tool as claimed in claim 1,
wherein an annular gap (46) on the protective cap (34) has a gap dimension between 0.05 mm and 1.5 mm.

12. A machine tool comprising
a spindle which is intended for clamping a tool (14), and
a spindle housing (16), on which the spindle is mounted, which spindle protrudes from the spindle housing (16) at a front end of the spindle housing (16),
wherein the spindle housing (16) forms, at its front end, a protective cap (34) towards the spindle, which protective cap (34) has, at the protective cap's front end (58), a diameter, which is smaller than a diameter at the protective cap's other, rearward end (54), and forms, at the front end (58), an annular gap (46) with a rotating part of the machine tool or the tool (14), at which annular gap (46), a positive pressure space supplied with air, terminates.

13. A protective cap for a machine tool comprising a spindle, a spindle housing (16) and a tool (14),
wherein the protective cap (34), which is mounted or fastened on a fixed part of the machine tool (10) has, at a front end (58), a diameter smaller than a diameter at an other, rearward end (54) and has, at the front end (58), a slender shape in comparison to the other rearward end (54), said slender shape approximating the end-side inner diameter (60) at the front end (58).

14. The protective cap as claimed in claim 13,
wherein said protective cap is fitted onto the spindle housing (16), when in the state of being fitted onto the spindle housing (16), has an annular nozzle flank (62) which, together with a rotating part of the machine tool, as a second annular nozzle flank, forms a nozzle in the form of an annular gap (46).

15. The protective cap as claimed in claim 13,
wherein the protective cap (34) covers a sealing air channel (40) and displaces the end of the sealing air channel (40) towards the tool or another rotating part.

16. The protective cap as claimed in claim 13,
wherein the seat of the protective cap (34) is formed as a threaded fit, a plug fit and/or as a press fit, by which the protective cap (34) can be mounted on a fixed part of the machine tool (10) by press fit and in a centered manner and/or wherein the protective cap (34) is formed on a seat in such a manner that it functions as a replacement part or as an accessory part for existing machine tools (10) and fits onto fixed parts thereof.

17. The machine tool as claimed in claim 1,
wherein the protective cap (34) comprises a radial extension in a front region adjacent to the annular gap (46) and extending over at least 30% of an axial total length, with respect to the rotating parts of the machine tool (10), a radial extension which exceeds that of the rotating parts by less than 15%.

18. The machine tool as claimed in claim 1,
wherein a bearings air channel (42) is formed on bearings (36, 38) of the spindle (12) and is supplied with positive pressure between 1 and 3 bar, and has a flow volume between 20 to 50 l/min.

19. The machine tool as claimed in claim 1,
wherein an annular gap (46) on the protective cap (34) has a gap dimension in one of the following ranges: between 0.05 and 1.0 mm or between 0.15 and 0.8 mm or between 0.3 and 0.5 mm.

20. The machine tool as claimed in claim 2,
wherein the other gap side is formed by the protective cap (34) at a nozzle flank 62.

21. The machine tool as claimed in claim 10,
wherein a bearings air passes through the bearings (36, 38) of the spindle (12) and is fed with filtered air or an ultra high purity, to ensure the absence of particles in the bearings (36, 38) of the spindle (12).

22. The machine tool as claimed in claim 10,
wherein at least one filter is provided upstream of the bearing air channel (42).

23. The machine tool as claimed in claim 11,
wherein the gap of the annular gap (46) on the protective cap (34) is not deformable, especially while rotating.

24. The machine too as claimed in claim 11,
wherein the gap width is constant, within a tolerance of 5 percent of the gap width, in all operating modes and operation states of said machine tool.

25. The machine tool as claimed in claim 11,
wherein the protective cap and the spindle are made from a solid and undeformable material.
